(19) United States
(12) Patent Application Publication
(10) Pub. No.: US 2021/0268786 A1
(43) Pub. Date: Sep. 2, 2021

(54) Flexible Laminated Film and Display Device Comprising Same

(71) Applicant: Dongwoo Fine-Chem Co., Ltd., Jeollabuk-do (KR)

(72) Inventors: Sung-Min Kim, Incheon (KR); Na-Youn Kim, Gyeonggi-do (KR)

(73) Assignee: Dongwoo Fine-Chem Co., Ltd., Jeollabuk-do (KR)

(21) Appl. No.: 17/173,091

(22) Filed: Feb. 10, 2021

(30) Foreign Application Priority Data
Feb. 28, 2020 (KR) 10-2020-0025248

(51) Int. Cl. B32B 37/12; B32B 7/12; B32B 27/08; B32B 27/28; B32B 27/30; B32B 27/32; B32B 27/36

(52) U.S. Cl. CPC B32B 37/1284; B32B 2457/202; B32B 27/08; B32B 27/281; B32B 27/308; B32B 27/325; B32B 27/36; B32B 2255/10; B32B 2255/26; B32B 2037/1253; B32B 2250/03; B32B 2250/24; B32B 2250/40; B32B 2305/72; B32B 2307/412; B32B 2307/536; B32B 2307/54; B32B 2307/732; B32B 2307/546; B32B 7/12

(57) ABSTRACT

The present invention relates to a flexible laminated film including a first substrate layer, an adhesive layer or a pressure-sensitive adhesive layer, a second substrate layer, and a hard coating layer, and to a display device including the flexible laminated film.

### BACKGROUND OF THE INVENTION

### 1. Technical Field

The present invention relates to a flexible laminated film and a display device including the flexible laminated film.

### 2. Description of the Related Art

With the increasing performance and popularization of portable display devices such as smartphones and tablet PCs, thorough research thereto is ongoing. For example, research and development is underway to commercialize a lightweight flexible (bendable or foldable) portable display device. A portable display device such as a liquid crystal display has a protective window for protecting a display module such as a liquid crystal layer, etc. Currently, most portable display devices use a window including a rigid glass substrate. However, since glass may be easily broken by an external impact, it is not only prone to breakage when applied to a portable display device, but also cannot be applied to a flexible display device because it is not flexible. Accordingly, attempts are being made to replace the protective window with a plastic film in a display device.

However, the mechanical properties (hardness) such as scratch resistance of the plastic film need to be further improved for use as a protective window of a display device, which is exposed to the external environment in daily life. In addition, at the same time, superior bending properties and flexibility for use in a flexible display device must also be satisfied. However, in a typical hard coating film, abrasion resistance increases due to an increase in crosslinking density, but curling occurs in the direction of the coating layer due to shrinkage of the coating layer. In addition, such curling causes troubles during the protective film bonding, black matrix (BM) processing, and anti-fingerprint layer processing, making processing difficult. In addition, when the curling becomes more severe, cracking may occur and bendability may decrease.

Korean Patent No. 10-1415838, pertaining to a hard coating composition, discloses a hard coating film in which a first hard coating layer and a second hard coating layer are formed on both surfaces of a support substrate using the hard coating composition. However, this film does not satisfy bending properties and flexibility at the level enabling commercialization of a flexible display device, particularly a foldable display device.

Accordingly, it is required to develop a film that simultaneously satisfies high hardness, flexibility and bending properties at the level enabling actual commercialization of a flexible display device.

### CITATION LIST

### Patent Literature

(Patent Document 1) Korean Patent No. 10-1415838

### SUMMARY OF THE INVENTION

The present invention has been made keeping in mind the problems encountered in the related art, and an objective of the present invention is to provide a flexible laminated film, which includes a hard coating layer, a first substrate layer, an adhesive layer or a pressure-sensitive adhesive layer, and a second substrate layer, has superior scratch resistance, flexibility, and bending properties, and exhibits low curling, and a display device including the flexible laminated film.

However, the objectives of the present invention are not limited to the foregoing, and other objectives not mentioned herein may be clearly understood by those skilled in the art through the following description.

In order to achieve the above objectives, the present invention provides a flexible laminated film, which includes a first substrate layer, a second substrate layer disposed on one surface of the first substrate layer, an adhesive layer or a pressure-sensitive adhesive layer interposed between the first substrate layer and the second substrate layer, and a hard coating layer disposed on the remaining surface of the first substrate layer, and satisfies Equation 1 and Equation 2 below.

$$\begin{matrix}80 μm \leq A 1 + A 2 + HC + B \leq 190 μm & [ Equation 1 ] \\ 6 \leq \frac{A 1 + A 2}{HC} \leq 16 & [ Equation 2 ]\end{matrix}$$

(In Equations 1 and 2, A1 is the thickness of the first substrate layer, A2 is the thickness of the second substrate layer, HC is the thickness of the hard coating layer, and B is the thickness of the adhesive layer or the pressure-sensitive adhesive layer.)

In addition, the present invention provides a display device including the flexible laminated film.

According to the present invention, a flexible laminated film has a total thickness of 80 to 190 μm, and the ratio of the sum of the thicknesses of the first and second substrate layers to the thickness of the hard coating layer satisfies the range of 6 to 16, whereby the flexible laminated film has superior flexibility at a bending radius of 2.5R, exhibits scratch resistance due to superior pencil hardness, and manifests low curling after curing, so it has superior processability without troubles in post-processes such as black matrix printing, anti-fingerprint layer coating, and the like.

### BRIEF DESCRIPTION OF DRAWING

FIG. 1 is a cross-sectional view of a flexible laminated film according to the present invention.

### DESCRIPTION OF SPECIFIC EMBODIMENTS

The present invention pertains to a flexible laminated film including a first substrate layer, an adhesive layer or a pressure-sensitive adhesive layer, a second substrate layer, and a hard coating layer, and to a display device including the flexible laminated film, in which the flexible laminated film may be used as a cover window substrate for a flexible display device.

<Flexible Laminated Film>

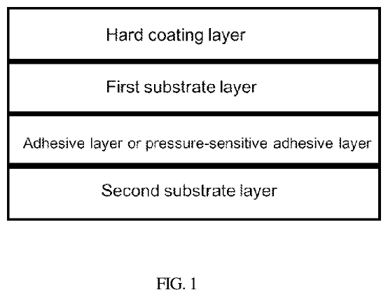

The flexible laminated film of the present invention includes a first substrate layer, a second substrate layer disposed on one surface of the first substrate layer, an adhesive layer or a pressure-sensitive adhesive layer interposed between the first substrate layer and the second substrate layer, and a hard coating layer disposed on the remaining surface of the first substrate layer (FIG. 1), and satisfies Equation 1 and Equation 2 below.

$$\begin{matrix}80 μm \leq A 1 + A 2 + HC + B \leq 190 μm & [ Equation 1 ] \\ 6 \leq \frac{A 1 + A 2}{HC} \leq 16 & [ Equation 2 ]\end{matrix}$$

In Equations 1 and 2, A1 is the thickness of the first substrate layer, A2 is the thickness of the second substrate layer, HC is the thickness of the hard coating layer, and B is the thickness of the adhesive layer or the pressure-sensitive adhesive layer.

As used herein, the “total thickness” means a value according to Equation 1, and the “thickness ratio” means a value according to Equation 2.

The laminated film of the present invention that satisfies the above-described configuration and Equations 1 and 2 has excellent pencil hardness and flexibility.

The flexible laminated film according to the present invention exhibits superior bending properties, and, for example, defects such as cracking, breaking, and lifting of the bent portion thereof do not occur upon bending for 240 hours with a bending radius of 2.5 mm (2.5R).

Moreover, the flexible laminated film according to the present invention has pencil hardness of 4H or more and thus superior scratch resistance, and, for example, pencil hardness is 4H or more, preferably 6H or more, and more preferably 8H or more under a load of 1 kg at the hard-coating-layer side.

As used herein, the “pencil hardness” is the maximum pencil hardness value that does not produce a scratch at least four out of five times upon evaluation using a pencil having a given pencil hardness, in the state in which the load on the laminated film is 1 kg, the pencil is set in a direction of 45°, and the laminated film is fixed on glass so that the lower coating layer is oriented toward the pencil.

Also, the flexible laminated film according to the present invention has superior anti-curling properties, and the difference between the edge and the highest portion of the film may be 5 mm or less. More specifically, the flexible laminated film of the present invention has curling of 5 mm or less after curing, and thus exhibits superior anti-curling properties, thereby providing high processability in post-processing.

As used herein, “curling” is a value obtained by measuring the maximum height from the support surface (flat surface) to the edge of the laminated film (four edges in the film cut in a rectangular shape) when the laminated film is cut to a predetermined size, placed on a support surface (flat surface), and then allowed to stand at about 25° C. and about 50% relative humidity, preferably for 24 hours.

First Substrate Layer

The flexible laminated film of the present invention includes a first substrate layer, and the first substrate layer functions to support the hard coating layer.

The first substrate layer preferably has a tensile modulus of 3 GPa or more, and more preferably, a tensile modulus of 4 GPa or more. When the tensile modulus of the first substrate layer is 3 GPa or more, superior hardness may be exhibited. If the tensile modulus of the first substrate layer is less than 3 GPa, the strength of the substrate film is weak despite the high hardness of the hard coating layer, so it is difficult to exhibit sufficient strength due to deformation of the film upon evaluation of pencil hardness. A tensile modulus of 3 GPa or more may be obtained by controlling the type of functional group, mol %, etc. during polymerization of the polymer constituting the first substrate layer.

The thickness of the first substrate layer is not particularly limited, so long as it satisfies Equations 1 and 2 below. For example, however, the thickness of the first substrate layer satisfying these equations is 10 to 190 μm, preferably 20 to 100 μm, and more preferably 30 to 80 M. When the total thickness according to Equation 1 is 80 to 190 μm and the thickness ratio according to Equation 2 is 6 to 16, the curling generated from the hard coating layer may be controlled to 5 mm or less. It is preferable for thickness of the first substrate layer to satisfy the following equations.

$$\begin{matrix}80 μm \leq A 1 + A 2 + HC + B \leq 190 μm & [ Equation 1 ] \\ 6 \leq \frac{A 1 + A 2}{HC} \leq 16 & [ Equation 2 ]\end{matrix}$$

In Equations 1 and 2, A1 is the thickness of the first substrate layer, A2 is the thickness of the second substrate layer, HC is the thickness of the hard coating layer, and B is the thickness of the adhesive layer or the pressure-sensitive adhesive layer.

The first substrate layer is a transparent plastic film, examples thereof including a cycloolefin-based derivative having a monomer unit including a cycloolefin such as norbornene or a polycyclic norbornene monomer, cellulose selected from among diacetyl cellulose, triacetyl cellulose, acetyl cellulose butyrate, isobutyl ester cellulose, propionyl cellulose, butyryl cellulose and acetylpropionyl cellulose, ethylene-vinyl acetate copolymer, polyester, polystyrene, polyamide, polyetherimide, polyacryl, polyimide, polyamideimide, polyethersulfone, polysulfone, polyethylene, polypropylene, polymethylpentene, polyvinyl chloride, polyvinylidene chloride, polyvinyl alcohol, polyvinyl acetal, polyether ketone, polyether ether ketone, polyether sulfone, polymethyl methacrylate, polyethylene terephthalate, polybutylene terephthalate, polyethylene naphthalate, polycarbonate, polyurethane, and epoxy.

Second Substrate Layer

The laminated film of the present invention further includes a second substrate layer disposed on one surface of the first substrate layer. Moreover, the second substrate layer that is used may be the same as the first substrate layer, and the tensile modulus of the second substrate layer is preferably 3 GPa or more, and more preferably 4 GPa or more. The tensile modulus of the flexible laminated film of the present invention excluding the hard coating layer, which includes the first substrate layer, the second substrate layer, and the adhesive layer and/or the pressure-sensitive adhesive layer, is preferably 4 GPa or more, and more preferably 5 GPa or more. When the tensile modulus of the laminated film including the first substrate layer and the second substrate layer is 4 GPa or more, rigidity may be improved and curling of the high-hardness thick hard coating layer may be prevented.

The thickness of the second substrate layer is not particularly limited, so long as it satisfies Equations 1 and 2 below, but, for example, the thickness of the second substrate layer satisfying the following equations may be 10 to 190 μm, preferably 20 to 100 μm, and more preferably 30 to 80 μm.

$$\begin{matrix}80 μm \leq A 1 + A 2 + HC + B \leq 190 μm & [ Equation 1 ] \\ 6 \leq \frac{A 1 + A 2}{HC} \leq 16 & [ Equation 2 ]\end{matrix}$$

In Equations 1 and 2, A1 is the thickness of the first substrate layer, A2 is the thickness of the second substrate layer, HC is the thickness of the hard coating layer, and B is the thickness of the adhesive layer or the pressure-sensitive adhesive layer.

When the total thickness according to Equation 1 is 80 to 190 μm and the thickness ratio according to Equation 2 is 6 to 16, the pencil hardness is 4H or more, and curling generated from the hard coating layer may be controlled to 5 mm or less, thus exhibiting high processability of the laminated film.

If the thickness ratio according to Equation 2 is less than 6, the thickness of the hard coating layer is greater than the thickness of the substrate layer and thus severe curling occurs, undesirably lowering processability. On the other hand, if the thickness ratio exceeds 16, the substrate may become thick and thus curling may be prevented, but due to the lack of flexibility, the resulting film cannot withstand a bending test at a bending radius of 2.5 mm.

The second substrate layer is a transparent plastic film, examples thereof including a cycloolefin-based derivative having a monomer unit including a cycloolefin such as norbornene or a polycyclic norbornene monomer, cellulose selected from among diacetyl cellulose, triacetyl cellulose, acetyl cellulose butyrate, isobutyl ester cellulose, propionyl cellulose, butyryl cellulose and acetylpropionyl cellulose, ethylene-vinyl acetate copolymer, polyester, polystyrene, polyamide, polyetherimide, polyacryl, polyimide, polyamideimide, polyethersulfone, polysulfone, polyethylene, polypropylene, polymethylpentene, polyvinyl chloride, polyvinylidene chloride, polyvinyl alcohol, polyvinyl acetal, polyether ketone, polyether ether ketone, polyether sulfone, polymethyl methacrylate, polyethylene terephthalate, polybutylene terephthalate, polyethylene naphthalate, polycarbonate, polyurethane, and epoxy.

Adhesive Layer or Pressure-Sensitive Adhesive Layer

The flexible laminated film of the present invention further includes an adhesive layer or a pressure-sensitive adhesive layer interposed between the first substrate layer and the second substrate layer, and the adhesive layer or the pressure-sensitive adhesive layer functions to attach the first substrate layer and the second substrate layer to each other. Moreover, the adhesive layer may include an adhesive, and the pressure-sensitive adhesive layer may include a pressure-sensitive adhesive.

The adhesive layer may be a layer containing an adhesive, and the thickness of the adhesive layer may be adjusted depending on the desired adhesion thereof, and may be 0.1 μm to 10 μm, and preferably 1 μm to 5 μm.

The adhesive of the present invention is characterized in that the substrate layer of the product is destroyed upon peeling after bonding processing and in that the peeled adhesive layer has no tackiness, and examples of the adhesive may include a water-based adhesive, in which an adhesive component is dissolved or dispersed in water, and an active-energy-ray-curable adhesive, which is cured through irradiation with active energy rays. The water-based adhesive may include a composition containing a polyvinyl-alcohol-based resin or a urethane resin as a main component, along with a crosslinking agent such as an isocyanate-based compound or an epoxy compound or a curable compound in order to improve adhesiveness.

When a polarizing coating layer and a retardation coating layer or retardation coating layers are adhered using a water-based adhesive, the water-based adhesive is injected between both coating layers, water is evaporated through a drying process, and a thermal crosslinking reaction proceeds to thereby impart sufficient adhesiveness to both layers.

Examples of the active-energy-ray-curable adhesive include a cationic polymerizable active-energy-ray-curable adhesive including an epoxy compound and a cationic polymerization initiator, a radical polymerizable active-energy-ray-curable adhesive including an acrylic curing component and a radical polymerization initiator, an active-energy-ray-curable adhesive including both a cationic polymerizable curing component such as an epoxy compound and a radical polymerizable curing component such as an acrylic compound and further including a cationic polymerization initiator and a radical polymerization initiator, an electron-beam-curable active-energy-ray-curable adhesive that is cured through irradiation with electron beams, and the like. The electron-beam-curable active-energy-ray-curable adhesive does not include an initiator. Among these, a cationic polymerizable active-energy-ray-curable adhesive including an epoxy compound and a cationic polymerization initiator is preferable. It is preferable that the active-energy-ray-curable adhesive include substantially no solvent. The active-energy-ray-curable adhesive is applied on a substrate and then cured through irradiation with active energy rays to form an adhesive layer.

The active-energy-ray-curable adhesive may include a sensitizer. By including the sensitizer, the reactivity may be improved, and the mechanical strength or adhesive strength of the adhesive layer may be further improved. Examples of the sensitizer include those described above. Moreover, the active-energy-ray-curable adhesive may be mixed with various additives within a range that does not impair the effect thereof. Examples of the additive capable of being mixed therewith include ion-trapping agents, antioxidants, chain transfer agents, tackifiers, thermoplastic resins, fillers, flow regulators, plasticizers, antifoaming agents, and the like.

In the present invention, active energy rays are defined as energy rays capable of generating an active species by decomposing a compound that generates an active species. Examples of the active energy rays include visible light, ultraviolet rays, infrared rays, X-rays, α rays, β rays, γ rays, and electron beams.

The pressure-sensitive adhesive layer may be a layer containing a pressure-sensitive adhesive, and the thickness of the pressure-sensitive adhesive layer may be adjusted depending on the desired pressure-sensitive adhesion thereof, and may be 2 μm to 50 μm, and preferably 2 μm to 25 μm.

The pressure-sensitive adhesive of the present invention is characterized in that peeling without great destruction of the substrate constituting the product after bonding processing is possible and in that the pressure-sensitive adhesive layer after peeling has tackiness that enables re-bonding. The pressure-sensitive adhesive may include an acrylic pressure-sensitive adhesive including an acrylic copolymer and a crosslinking agent. The acrylic copolymer may be prepared through radical polymerization of a (meth)acrylate monomer having a C1-C12 alkyl group and a polymerizable monomer having a crosslinkable functional group. Here, “(meth)acrylate” includes acrylate and methacrylate.

Specific examples of the (meth)acrylate monomer having a C1-C12 alkyl group include n-butyl (meth)acrylate, 2-butyl (meth)acrylate, t-butyl (meth)acrylate, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, nonyl (meth)acrylate, decyl (meth)acrylate, lauryl (meth)acrylate, and the like, among which n-butyl acrylate, methyl acrylate or a mixture thereof is preferred. These may be used alone or in combinations of two or more thereof. The polymerizable monomer having a crosslinkable functional group is a component for imparting durability and cutability by reinforcing cohesion or pressure-sensitive adhesive strength of the pressure-sensitive adhesive through chemical bonding with the crosslinking agent. Examples thereof may include a monomer having a hydroxy group, a monomer having a carboxyl group, a monomer having an amide group, a monomer having a tertiary amine group, and the like, which may be used alone or in combinations of two or more thereof.

Examples of the monomer having a hydroxy group may include 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 2-hydroxyethylene glycol (meth)acrylate, 2-hydroxypropylene glycol (meth)acrylate, hydroxyalkylene glycol (meth)acrylate having a C2-C4 alkylene group, 4-hydroxybutyl vinyl ether, 5-hydroxypentyl vinyl ether, 6-hydroxyhexyl vinyl ether, 7-hydroxyheptyl vinyl ether, 8-hydroxyoctyl vinyl ether, 9-hydroxynonyl vinyl ether, 10-hydroxydecyl vinyl ether, and the like. Among these, 2-hydroxyethyl (meth)acrylate or 4-hydroxybutyl vinyl ether is preferable.

Examples of the monomer having a carboxyl group include monoacids such as (meth)acrylic acid, crotonic acid, etc.; diacids such as maleic acid, itaconic acid, fumaric acid, etc., and monoalkyl esters thereof; 3-(meth)acryloylpropionic acid; succinic anhydride ring-opening adducts of 2-hydroxyalkyl (meth)acrylate having a C2-C3 alkyl group, succinic anhydride ring-opening adducts of hydroxyalkylene glycol (meth)acrylate having a C2-C4 alkylene group, and compounds obtained by ring-opening addition of succinic anhydride to a caprolactone adduct of 2-hydroxyalkyl (meth)acrylate having a C2-C3 alkyl group, and the like. Among these, (meth)acrylic acid is preferable.

Examples of the monomer having an amide group include (meth)acrylamide, N-isopropylacrylamide, N-tertiary butylacrylamide, 3-hydroxypropyl (meth)acrylamide, 4-hydroxybutyl (meth)acrylamide, 6-hydroxyhexyl (meth)acrylamide, 8-hydroxyoctyl (meth)acrylamide, 2-hydroxyethylhexyl (meth)acrylamide, and the like. Among these, (meth)acrylamide is preferable.

Examples of the monomer having a tertiary amine group include N,N-(dimethylamino)ethyl(meth)acrylate, N,N-(diethylamino)ethyl(meth)acrylate, N,N-(dimethylamino)propyl(meth)acrylate, and the like.

The polymerizable monomer having a crosslinkable functional group is preferably contained in an amount of 0.05 to 10 parts by weight, and more preferably 0.1 to 8 parts by weight, based on 100 parts by weight of the (meth)acrylate monomer having a C1-C12 alkyl group. If the amount thereof is less than 0.05 parts by weight, the cohesion of the pressure-sensitive adhesive may decrease, and durability may thus be deteriorated. On the other hand, if the amount thereof exceeds 10 parts by weight, pressure-sensitive adhesion may decrease due to a high gel fraction, and durability may become problematic. The acrylic copolymer may further contain a polymerizable monomer, other than the above monomers, in an amount that does not deteriorate the pressure-sensitive adhesion, for example, 10 wt % or less based on the total amount thereof. The method of preparing the acrylic copolymer is not particularly limited, and may include bulk polymerization, solution polymerization, emulsion polymerization or suspension polymerization commonly used in the art, among which solution polymerization is preferable. Moreover, a solvent commonly used for polymerization, a polymerization initiator, a chain transfer agent for molecular weight control, and the like may be used. The acrylic copolymer has a weight average molecular weight (in terms of polystyrene) measured by gel permeation chromatography (GPC) of 50,000 to 2,000,000, and preferably 500,000 to 2,000,000.

The crosslinking agent is a component for strengthening the cohesion of the pressure-sensitive adhesive by appropriately crosslinking the copolymer, and the type thereof is not particularly limited. Examples thereof may include isocyanate-based compounds, epoxy-based compounds, and the like, which may be used alone or in combinations of two or more thereof.

Examples of the isocyanate-based compound include diisocyanate compounds, such as tolylene diisocyanate, xylene diisocyanate, 2,4-diphenylmethane diisocyanate, 4,4-diphenylmethane diisocyanate, hexamethylene diisocyanate, isophorone diisocyanate, tetramethylxylene diisocyanate, naphthalene diisocyanate, etc.; multifunctional isocyanate compounds containing three functional groups, such as adducts obtained by reacting 3 moles of a diisocyanate compound with 1 mole of a polyhydric alcohol compound such as trimethylolpropane, isocyanurates obtained by self-condensing 3 moles of a diisocyanate compound, biurets obtained by condensing diisocyanate urea, obtained from 2 moles among 3 moles of a diisocyanate compound, with the remaining 1 mole of diisocyanate, triphenylmethane triisocyanate, methylenebis(triisocyanate), etc., and the like.

Examples of the epoxy-based compound include ethylene glycol diglycidyl ether, diethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, polytetramethylene glycol diglycidyl ether, glycerol diglycidyl ether, glycerol triglycidyl ether, diglycerol polyglycidyl ether, polyglycerol polyglycidyl ether, resorcin diglycidyl ether, 2,2-dibromoneopentyl glycol diglycidyl ether, trimethylolpropane triglycidyl ether, pentaerythritol polyglycidyl ether, sorbitol polyglycidyl ether, adipic acid diglycidyl ester, phthalic acid diglycidyl ester, tris(glycidyl) isocyanurate, tris(glycidoxyethyl) isocyanurate, 1,3-bis(N,N-glycidylaminomethyl)cyclohexane, N,N,N′,N′-tetraglycidyl-m-xylylenediamine, and the like. Also, melamine-based compounds may be additionally used alone or in combinations of two or more thereof along with the isocyanate-based compounds and the epoxy-based compounds. Examples of the melamine-based compound include hexamethylolmelamine, hexamethoxymethylmelamine, hexabutoxymethylmelamine, and the like.

The crosslinking agent is preferably contained in an amount of 0.1 to 5 parts by weight, and more preferably 0.1 to 2 parts by weight, based on 100 parts by weight of the acrylic copolymer. If the amount thereof is less than 0.1 parts by weight, cohesion may decrease due to insufficient crosslinkability, resulting in deteriorated durability, evidenced by, for example, lifting, and impairing cutting properties. On the other hand, if the amount thereof exceeds 5 parts by weight, a problem may occur in relieving residual stress due to the excessive crosslinking reaction.

Each component constituting the pressure-sensitive adhesive is dissolved in a suitable solvent such as ethyl acetate to obtain a pressure-sensitive adhesive composition, and the pressure-sensitive adhesive composition is applied on a substrate and then dried to form an adhesive layer. In the case in which there are some components that are not soluble in the solvent, they may be in the state of being dispersed in the system.

Hard Coating Layer

The flexible laminated film of the present invention includes a hard coating layer disposed on the remaining surface of the first substrate layer, and the hard coating layer imparts superior hardness to the laminated film.

The thickness of the hard coating layer may be 3 to 100 μm, preferably 5 to 80 μm, and more preferably 10 to 60 μm. A thick hard coating layer is preferable in view of pencil hardness, but the thicker the hard coating layer, the more severe the curling due to curing shrinkage. Also, as the degree of curing of the hard coating layer increases, pencil hardness increases, but curling inevitably results. In particular, as the thickness thereof is increased in order to improve pencil hardness, curling becomes more severe, and thus, during automated processing in the protective film bonding, black matrix (BM) processing, and anti-fingerprint layer processing in post-processes, processing difficulties in which it becomes impossible to perform transfer to subsequent processes occur due to curling of the laminated film. Therefore, when a high-hardness thick hard coating layer is used, there is a need to prevent curling, which may be solved in the present invention by optimizing the thickness ratio of the substrate layer and the hard coating layer, as described in more detail in the description regarding the second substrate layer.

It is preferable that the hard coating layer have Martens hardness of 350 N/mm² or more. When the hard coating layer has Martens hardness of 350 N/mm² or more and is used along with the aforementioned first and second substrate layers, high pencil hardness of 4H or more may be realized.

In order to suppress the cracking due to repeated bending fatigue while implementing high hardness, Martens hardness is preferably 350 N/mm² to 500 N/mm², and more preferably 350 N/mm² to 450 N/mm². The Martens hardness may be measured under a load of 10 mN by a nano indentation method, and a Martens hardness in the above range may be obtained by adjusting the degree of curing depending on changes in the type and amount of light-transmissive resin, the type and amount of photoinitiator, etc., within the range of the type and amount of the hard coating layer composition described below, or by further including a filler such as silica particles.

The hard coating layer may be formed by applying a composition for forming a hard coating layer including a light-transmissive resin, a photoinitiator, and a solvent known in the art on the first substrate layer and performing curing.

The light-transmissive resin may include a photocurable (meth)acrylate oligomer, a photocurable monomer, and the like, which may be used alone or in combinations of two or more thereof. The photocurable (meth)acrylate oligomer may be at least one selected from the group consisting of epoxy (meth)acrylate, urethane (meth)acrylate and polyester (meth)acrylate, and specifically, urethane (meth)acrylate and polyester (meth)acrylate may be used in combination, or two types of polyester (meth)acrylate may be used in combination.

The urethane (meth)acrylate may be prepared by reacting a multifunctional (meth)acrylate having a hydroxyl group in the molecule thereof and a compound having an isocyanate group in the presence of a catalyst according to a method known in the art.

Specific examples of the multifunctional (meth)acrylate having a hydroxy group in the molecule thereof may include at least one selected from the group consisting of 2-hydroxyethyl (meth)acrylate, 2-hydroxyisopropyl (meth)acrylate, 4-hydroxybutyl (meth)acrylate, caprolactone ring-opened hydroxyacrylate, pentaerythritol tri/tetra(meth)acrylate mixtures, and dipentaerythritol penta/hexa(meth)acrylate mixtures.

Specific examples of the compound having an isocyanate group may include at least one selected from the group consisting of 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexene diisocyanate, 4,4′-methylenebis(cyclohexyl isocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis(2,6-dimethylphenyl isocyanate), 4,4′-oxybis(phenyl isocyanate), trifunctional isocyanate derived from hexamethylene diisocyanate, and trimethylene propanol adduct toluene diisocyanate.

The polyester (meth)acrylate may be prepared by reacting polyester polyol and acrylic acid according to a method known in the art.

The polyester (meth)acrylate may include, for example, at least one selected from the group consisting of polyester acrylate, polyester diacrylate, polyester tetraacrylate, polyester hexaacrylate, polyester pentaerythritol triacrylate, polyester pentaerythritol tetraacrylate, and polyester pentaerythritol hexaacrylate, but is not limited thereto.

Examples of the photocurable monomer may include, but are not limited to, monomers used in the art having, in the molecule thereof, an unsaturated group such as a (meth)acryloyl group, a vinyl group, a styryl group, an allyl group, etc. as the photocurable functional group that is typically used, and particularly, a monomer having a (meth)acryloyl group may be used.

The monomer having a (meth)acryloyl group may include, for example, at least one selected from the group consisting of neopentyl glycol acrylate, 1,6-hexanediol (meth)acrylate, propylene glycol di(meth)acrylate, triethylene glycol di(meth)acrylate, dipropylene glycol di(meth)acrylate, polyethylene glycol di(meth)acrylate, polypropylene glycol di(meth)acrylate, trimethylolpropane tri(meth)acrylate, trimethylolethane tri(meth)acrylate, 1,2,4-cyclohexane tetra(meth)acrylate, pentaglycerol tri(meth)acrylate, pentaerythritol tetra(meth)acrylate, pentaerythritol tri(meth)acrylate, dipentaerythritol tri(meth)acrylate, dipentaerythritol penta(meth)acrylate, dipentaerythritol tetra(meth)acrylate, dipentaerythritol hexa(meth)acrylate, tripentaerythritol tri(meth)acrylate, tripentaerythritol hexa(meth)acrylate, bis(2-hydroxyethyl)isocyanurate di(meth)acrylate, hydroxyethyl (meth)acrylate, hydroxypropyl (meth)acrylate, hydroxybutyl (meth)acrylate, isooctyl (meth)acrylate, isodecyl (meth)acrylate, stearyl (meth)acrylate, tetrahydrofurfuryl (meth)acrylate, phenoxyethyl (meth)acrylate, and isoborneol (meth)acrylate, but is not limited thereto.

In particular, it is possible to increase the workability and compatibility of the photocurable coating composition by using the photocurable monomer within the amount range of the (meth)acrylate included in the mixture composition with the tetrafunctional polyester (meth)acrylate, and properties equivalent thereto may be obtained.

The light-transmissive resin affects the quality of the coating film, and may be used in an amount of 1 to 80 wt %, and preferably 5 to 50 wt %, based on the total weight of the composition for forming a hard coating layer. If the amount thereof is less than 1 wt %, it may be difficult to form a coating film, or it may be difficult to implement sufficient hardness, whereas if the amount thereof exceeds 80 wt %, curling may become severe after curing the coating film. Metal oxide microparticles may be added to the light-transmissive resin in order to improve hardness and reduce shrinkage.

The photoinitiator may be used without limitation, so long as it is one that is useful in the art. For example, at least one selected from the group consisting of hydroxy ketones, amino ketones, hydrogen abstraction photoinitiators, and combinations thereof may be used.

Specifically, the photoinitiator may be at least one selected from the group consisting of 2-methyl-1-[4-(methylthio)phenyl]2-morpholinepropanone-1, diphenyl ketone, benzyldimethylketal, 2-hydroxy-2-methyl-1-phenyl-1-one, 4-hydroxycyclophenylketone, 2,2-dimethoxy-2-phenyl-acetophenone, anthraquinone, fluorene, triphenylamine, carbazole, 3-methylacetophenone, 4-chloroacetophenone, 4,4-dimethoxyacetophenone, 4,4-diaminobenzophenone, 1-hydroxycyclohexylphenylketone, benzophenone, diphenyl(2,4,6-trimethylbenzoyl)phosphine oxide, and combinations thereof.

The photoinitiator may be used in an amount of 0.1 to 10 wt %, and preferably 1 to 5 wt %, based on the total weight of the composition for forming a hard coating layer. If the amount thereof is less than 0.1 wt %, the curing speed of the composition may be slow, or curing may not occur, resulting in a deterioration in mechanical properties, whereas if the amount thereof exceeds 10 wt %, cracking may occur in the coating film due to overcuring.

The composition for forming a hard coating layer of the present invention may further include silica particles as needed.

The silica particles serve to improve the hardness of the hard coating layer, and the particle diameter thereof is preferably 1 to 100 nm. If the particle diameter thereof is less than 1 nm, dispersibility in the hard coating composition may decrease, whereas if the particle diameter thereof exceeds 100 nm, haziness may increase.

It is preferable to use silica particles dispersed in a monomer, and specifically, any one selected from the group consisting of Nanocryl C130, Nanocryl C140, Nanocryl C145, Nanocryl C146, Nanocryl C150, Nanocryl C153, Nanocryl C155, Nanocryl C165, Nanocryl C350, Nanocryl C620, and Nanocryl C680, which are commercially available products, may be used.

The silica particles may be used in an amount of 1 to 50 wt %, and preferably 10 to 30 wt %, based on the total weight of the composition for forming a hard coating layer. If the amount thereof is less than 1 wt %, the effect of improving hardness may be insignificant, whereas if the amount thereof exceeds 50 wt %, cracking may occur on the hardened surface.

The solvent is not particularly limited, so long as it is able to dissolve or disperse the above components.

Specific examples of the solvent may include alcohols (methanol, ethanol, isopropanol, butanol, methyl cellosolve, ethyl cellosolve, etc.), ketones (methyl ethyl ketone, methyl butyl ketone, methyl isobutyl ketone, diethyl ketone, dipropyl ketone, cyclohexanone, etc.), acetates (ethyl acetate, propyl acetate, normal butyl acetate, tertiary butyl acetate, methyl cellosolve acetate, ethyl cellosolve acetate, propylene glycol monomethyl ether acetate, propylene glycol monoethyl ether acetate, propylene glycol monopropyl ether acetate, methoxybutyl acetate, methoxypentyl acetate, etc.), hexanes (hexane, heptane, octane, etc.), benzenes (benzene, toluene, xylene, etc.), ethers (diethylene glycol dimethyl ether, diethylene glycol diethyl ether, diethylene glycol dipropyl ether, diethylene glycol dibutyl ether, propylene glycol monomethyl ether, etc.), and the like. The solvents listed above may be used alone or in combinations of two or more thereof.

The solvent may be used in an amount of 10 to 95 wt % based on the total weight of the composition for forming the hard coating layer. If the amount thereof is less than 10 wt %, workability may be deteriorated due to the high viscosity thereof, whereas if the amount thereof exceeds 95 wt %, the drying process may take a long time, and economic efficiency may decrease.

<Display Device>

In addition, the present invention pertains to a display device including the flexible laminated film according to the present invention. In the display device according to the present invention, all of the description of the flexible laminated film may be applied, and an overlapping description is omitted, but may be equally applied even when omitted.

The display device of the present invention includes the laminated film as a cover window substrate.

The display device of the present invention may be a liquid crystal display device, an electroluminescent display device, a plasma display device, a field emission display device, or the like, and may also be a flexible image display device.

A better understanding of the present invention may be obtained via the following examples. However, these examples are merely set forth to illustrate the present invention, and are not to be construed as limiting the scope of the present invention.

### PREPARATION EXAMPLE 1: PREPARATION OF COMPOSITION FOR FORMING HARD COATING LAYER

A composition for forming a hard coating layer was prepared by mixing 10 parts by weight of urethane acrylate (10-functional, Miwon Commercial, SC2153), 10 parts by weight of pentaerythritol triacrylate, 50 parts by weight of nano silica sol (12 nm, solid content of 40%, Catalysts & Chemicals Industries, V8802), 20 parts by weight of methyl ethyl ketone (Daejung Chemicals & Metals), 7 parts by weight of propylene glycol monomethyl ether (Daejung Chemicals & Metals), 2.7 parts by weight of a photoinitiator (Shiba, 1-184), and 0.3 parts by weight of a leveling agent (BYK Chemie, BYKUV3570) using a stirrer, followed by filtration using a filter made of a PP material.

### PREPARATION EXAMPLE 2: PREPARATION OF COMPOSITION FOR FORMING HARD COATING LAYER

A composition for forming a hard coating layer was prepared by mixing 5 parts by weight of urethane acrylate (10-functional, Miwon Specialty Chemical, SC2153), 35 parts by weight of pentaerythritol triacrylate, 37 parts by weight of methyl ethyl ketone, 20 parts by weight of propylene glycol monomethyl ether, 2.7 parts by weight of a photoinitiator (Shiba, 1-184), and 0.3 parts by weight of a leveling agent (BYK Chemie, BYK-UV3570) using a stirrer, followed by filtration using a filter made of a PP material.

### EXAMPLES AND COMPARATIVE EXAMPLES: PREPARATION OF HARD COATING LAMINATED FILM

### Example 1

A laminated film was manufactured by adhering a polyimide film (30 μm, a first substrate layer) and a polyimide film (40 μm, a second substrate layer) using an acrylic adhesive layer (having a thickness of 5 μm). Thereafter, the composition of Preparation Example 1 was applied on the first substrate layer such that the thickness thereof after curing was 10 μm, followed by solvent drying and UV curing to form a hard coating layer, thereby manufacturing a hard coating laminated film.

### Example 2

A laminated film was manufactured by adhering a polyimide film (50 μm, a first substrate layer) and a polyimide film (50 μm, a second substrate layer) using an acrylic adhesive layer (having a thickness of 5 μm). Thereafter, the composition of Preparation Example 1 was applied on the first substrate layer such that the thickness thereof after curing was 10 μm, followed by solvent drying and UV curing to form a hard coating layer, thereby manufacturing a hard coating laminated film.

### Example 3

A laminated film was manufactured by adhering a polyimide film (50 μm, a first substrate layer) and a cycloolefin (COP) film (50 μm, a second substrate layer) using an acrylic adhesive layer (having a thickness of 5 μm). Thereafter, the composition of Preparation Example 1 was applied on the first substrate layer such that the thickness thereof after curing was 10 μm, followed by solvent drying and UV curing to form a hard coating layer, thereby manufacturing a hard coating laminated film.

### Example 4

A laminated film was manufactured by adhering a polyimide film (50 μm, a first substrate layer) and polyethylene terephthalate (50 μm, a second substrate layer) using an acrylic pressure-sensitive adhesive layer (having a thickness of 25 μm). Thereafter, the composition of Preparation Example 1 was applied on the first substrate layer such that the thickness thereof after curing was 10 μm, followed by solvent drying and UV curing to form a hard coating layer, thereby manufacturing a hard coating laminated film.

### Example 5

A laminated film was manufactured by adhering a polyimide film (80 μm, a first substrate layer) and polyethylene terephthalate (80 μm, a second substrate layer) using an acrylic adhesive layer (having a thickness of 5 μm). Thereafter, the composition of Preparation Example 1 was applied on the first substrate layer such that the thickness thereof after curing was 10 μm, followed by solvent drying and UV curing to form a hard coating layer, thereby manufacturing a hard coating laminated film.

### Example 6

A laminated film was manufactured by adhering a polyimide film (80 μm, a first substrate layer) and a polyimide film (80 μm, a second substrate layer) using an acrylic adhesive layer (having a thickness of 5 μm). Thereafter, the composition of Preparation Example 1 was applied on the first substrate layer such that the thickness thereof after curing was 25 μm, followed by solvent drying and UV curing to form a hard coating layer, thereby manufacturing a hard coating laminated film.

### Comparative Example 1

The composition of Preparation Example 1 was applied on a polyimide film (50 μm, a first substrate layer) such that the thickness thereof after curing was 10 μm, followed by solvent drying and UV curing to form a hard coating layer, thereby manufacturing a hard coating laminated film.

### Comparative Example 2

The composition of Preparation Example 1 was applied on a polyimide film (50 μm, a first substrate layer) such that the thickness thereof after curing was 5 μm, followed by solvent drying and UV curing to form a hard coating layer, thereby manufacturing a hard coating laminated film.

### Comparative Example 3

A laminated film was manufactured by adhering a polyimide film (50 μm, a first substrate layer) and a polyimide film (50 μm, a second substrate layer) using an acrylic adhesive layer (having a thickness of 5 μm). Thereafter, the composition of Preparation Example 1 was applied on the first substrate layer such that the thickness thereof after curing was 20 μm, followed by solvent drying and UV curing to form a hard coating layer, thereby manufacturing a hard coating laminated film.

### Comparative Example 4

A laminated film was manufactured by adhering a polyimide film (80 μm, a first substrate layer) and polyethylene terephthalate (80 μm, a second substrate layer) using an acrylic adhesive layer (having a thickness of 5 μm). Thereafter, the composition of Preparation Example 1 was applied on the first substrate layer such that the thickness thereof after curing was 30 μm, followed by solvent drying and UV curing to form a hard coating layer, thereby manufacturing a hard coating laminated film.

### Comparative Example 5

A laminated film was manufactured by adhering a polyimide film (80 μm, a first substrate layer) and polyethylene terephthalate (100 μm, a second substrate layer) using an acrylic adhesive layer (having a thickness of 5 μm). Thereafter, the composition of Preparation Example 1 was applied on the first substrate layer such that the thickness thereof after curing was 10 μm, followed by solvent drying and UV curing to form a hard coating layer, thereby manufacturing a hard coating laminated film.

### Comparative Example 6

A laminated film was manufactured by adhering a polyimide film (30 μm, a first substrate layer) and a polyimide film (40 μm, a second substrate layer) using an acrylic adhesive layer (having a thickness of 5 μm). Thereafter, the composition of Preparation Example 2 was applied on the first substrate layer such that the thickness thereof after curing was 10 μm, followed by solvent drying and UV curing to form a hard coating layer, thereby manufacturing a hard coating laminated film.

### Comparative Example 7

A laminated film was manufactured by adhering a cycloolefin (COP) film (50 μm, a first substrate layer) and a cycloolefin (COP) film (50 μm, a second substrate layer) using an acrylic adhesive layer (having a thickness of 5 μm). Thereafter, the composition of Preparation Example 2 was applied on the first substrate layer such that the thickness thereof after curing was 10 μm, followed by solvent drying and UV curing to form a hard coating layer, thereby manufacturing a hard coating laminated film.

### Comparative Example 8

A laminated film was manufactured by adhering a polyimide film (50 μm, a first substrate layer) and polyethylene terephthalate (50 μm, a second substrate layer) using an acrylic pressure-sensitive adhesive layer (having a thickness of 25 μm). Thereafter, the composition of Preparation Example 1 was applied on the first substrate layer such that the thickness thereof after curing was 20 μm, followed by solvent drying and UV curing to form a hard coating layer, thereby manufacturing a hard coating laminated film.

The conditions of the hard coating laminated films manufactured in Examples 1 to 6 and Comparative Examples 1 to 8 are summarized in Table 1 below.

TABLE 1

| | A1 | B | A2 | HC | Total | Thickness |
|---|---|---|---|---|---|---|
| | (μm) | (μm) | (μm) | (μm) | thickness | ratio |
| Example 1 | 30 | 5 | 40 | 10 | 85 | 7 |
| Example 2 | 50 | 5 | 50 | 10 | 115 | 10 |
| Example 3 | 50 | 5 | 50 | 10 | 115 | 10 |
| Example 4 | 50 | 25 | 50 | 10 | 135 | 10 |
| Example 5 | 80 | 5 | 80 | 10 | 175 | 16 |
| Example 6 | 80 | 5 | 80 | 25 | 190 | 6.4 |
| Comparative | 50 | 0 | 0 | 10 | 60 | 5 |
| Example 1 | | | | | | |
| Comparative | 50 | 0 | 0 | 5 | 55 | 10 |
| Example 2 | | | | | | |
| Comparative | 50 | 5 | 50 | 20 | 125 | 5 |
| Example 3 | | | | | | |
| Comparative | 80 | 5 | 80 | 30 | 195 | 5.3 |
| Example 4 | | | | | | |
| Comparative | 80 | 5 | 100 | 10 | 195 | 18 |
| Example 5 | | | | | | |
| Comparative | 30 | 5 | 40 | 10 | 85 | 7 |
| Example 6 | | | | | | |
| Comparative | 50 | 5 | 50 | 10 | 115 | 10 |
| Example 7 | | | | | | |
| Comparative | 50 | 25 | 50 | 20 | 145 | 5 |
| Example 8 | | | | | | |

HC = thickness of hard coating layer (Preparation Example 1 or 2) (μm)
A1 = thickness of first substrate layer (μm)
B = thickness of adhesive layer or pressure-sensitive adhesive layer (μm)
A2 = thickness of second substrate layer (μm)
Total thickness = A1 + A2 + B + HC (μm)
Thickness ratio = (A1 + A2)/HC

### Test Example 1: Measurement of Modulus

Using an autograph tester made by Shimadzu, the laminated film before formation of the hard coating layer in each of Examples 1 to 6 and Comparative Examples 1 to 8 was cut to a width of 5 mm and a length of 100 mm using a Super cutter, after which the modulus was determined in the modulus calculation section at 20 to 40 MPa after measurement at a gage distance of 50 mm and a tensile speed of 5 mm/min. The results thereof are shown in Table 2 below.

### Test Example 2: Measurement of Martens Hardness

The composition for forming the hard coating layer of each of Preparation Examples 1 and 2 was applied on glass such that the thickness thereof after curing was 5 μm, followed by drying and UV curing to obtain a sample, the surface of the hard coating layer of which was then measured for hardness under a load of 10 mN using a nano indenter. The results thereof are shown in Table 2 below.

### Test Example 3: Evaluation of Curling

The evaluation sample manufactured in each of Examples 1 to 6 and Comparative Examples 1 to 8 was cut to a size of 100×100 mm and allowed to stand at 25° C. and 50% relative humidity for 24 hours, after which the evaluation sample was placed on a flat surface and the height between the curled edges (4 positions) of the evaluation sample and the flat surface was measured, and the greatest numerical value was recorded. The results thereof are shown in Table 2 below.

### Test Example 4: Evaluation of Flexibility

The evaluation sample manufactured in each of Examples 1 to 6 and Comparative Examples 1 to 8 was cut to a length of 110 mm×a width of 20 mm and fixed to the surfaces of two glass substrates so that the bending axis was in the width direction, the opposite side of the glass substrates corresponding to a window. Thereafter, the hard coating surface of the window was bent with a bending radius of 2.5 mm (2.5R) so as to face itself, after which the bent state thereof was fixed, followed by storage at room temperature for 240 hours. Thereafter, defects such as cracking, breaking, and lifting of the bent portion of the evaluation sample were observed. The results thereof are shown in Table 2 below.

O: There are no defects such as cracking, breaking, or lifting on the bent portion.

X: There is breaking or lifting on the bent portion.

### Test Example 5: Measurement of Pencil Hardness

In order to measure the pencil hardness of the laminated film manufactured in each of Examples 1 to 6 and Comparative Examples 1 to 8, a pencil was set under a load of 1 kg in a direction of 45°, the coating film was fixed on glass so that the coating surface was oriented toward the pencil, and pencil hardness was expressed as the hardness at which a scratch was not produced at least four out of five times upon evaluation using a pencil having a given pencil hardness. The results thereof are shown in Table 2 below.

TABLE 2

| | | Martens | | | Pencil |
|---|---|---|---|---|---|
| | Modulus | hardness | Curling | Flexibility | hardness |
| Example 1 | 5.8 GPa | 366 N/mm² | 3 mm | ◯ | 5H |
| Example 2 | 5.6 GPa | 366 N/mm² | 1 mm | ◯ | 6H |
| Example 3 | 4.3 GPa | 366 N/mm² | 3 mm | ◯ | 4H |
| Example 4 | 4.2 GPa | 366 N/mm² | 0 mm | ◯ | 6H |
| Example 5 | 5.2 GPa | 366 N/mm² | 0 mm | ◯ | 8H |
| Example 6 | 5.6 GPa | 366 N/mm² | 5 mm | ◯ | 8H |
| Comparative | 6.2 GPa | 366 N/mm² | 14 mm | ◯ | 3H |
| Example 1 | | | | | |
| Comparative | 6.2 GPa | 366 N/mm² | 6 mm | ◯ | 3H |
| Example 2 | | | | | |
| Comparative | 5.6 GPa | 366 N/mm² | 12 mm | X | 5H |
| Example 3 | | | | | |
| Comparative | 5.6 GPa | 366 N/mm² | 8 mm | X | 8H |
| Example 4 | | | | | |
| Comparative | 4.9 GPa | 366 N/mm² | 0 mm | X | 5H |
| Example 5 | | | | | |
| Comparative | 5.7 GPa | 312 N/mm² | 0 mm | ◯ | 2H |
| Example 6 | | | | | |
| Comparative | 2.8 GPa | 312 N/mm² | 8 mm | ◯ | 2H |
| Example 7 | | | | | |
| Comparative | 4.2 GPa | 366 N/mm² | 7 mm | X | 8H |
| Example 8 | | | | | |

As is apparent from Table 2, the laminated films of Examples, having a modulus of 4.0 GPa or more and satisfying the total thickness and the thickness ratio, did not cause curling, or caused curling of 5 mm or less, and simultaneously exhibited superior flexibility at a bending radius of 2.5R and high pencil hardness of 4H or more. Also, in Examples 2 and 3, in which the thickness range and the thickness ratio are the same conditions, it was confirmed that Example 2, having a higher modulus, exhibited vastly superior pencil hardness.

In contrast, Comparative Examples 1 to 5 and 8, which did not satisfy the total thickness and/or the thickness ratio, exhibited curling of 5 mm or more, low flexibility, or low pencil hardness. Also, Comparative Examples 6 and 7, in which the total thickness and/or the thickness ratio were satisfied but a hard coating layer having Martens hardness of less than 350 N/mm² was used, exhibited very low pencil hardness.

1. A flexible laminated film, comprising:
a first substrate layer;
a second substrate layer disposed on one surface of the first substrate layer;
an adhesive layer or a pressure-sensitive adhesive layer interposed between the first substrate layer and the second substrate layer; and
a hard coating layer disposed on a remaining surface of the first substrate layer,
wherein the flexible laminated film satisfies Equation 1 and Equation 2 below:
$$\begin{matrix}80 μm \leq A 1 + A 2 + HC + B \leq 190 μm & [ Equation 1 ] \\ 6 \leq \frac{A 1 + A 2}{HC} \leq 16 & [ Equation 2 ]\end{matrix}$$
(in Equation 1 and Equation 2, A1 is a thickness of the first substrate layer, A2 is a thickness of the second substrate layer, HC is a thickness of the hard coating layer, and B is a thickness of the adhesive layer or the pressure-sensitive adhesive layer).

2. The flexible laminated film of claim 1, wherein the first substrate layer and the second substrate layer are each independently a transparent plastic substrate.

3. The flexible laminated film of claim 1, wherein a tensile modulus of the flexible laminated film excluding the hard coating layer is 4 GPa or more.

4. The flexible laminated film of claim 1, wherein a pencil hardness of the flexible laminated film is 4H or more.

5. The flexible laminated film of claim 1, wherein the adhesive layer comprises an adhesive, and the pressure-sensitive adhesive layer comprises a pressure-sensitive adhesive.

6. The flexible laminated film of claim 1, wherein the thickness of the adhesive layer is 0.1 μm to 10 μm.

7. The flexible laminated film of claim 1, wherein the thickness of the pressure-sensitive adhesive layer is 2 μm to 50 μm.

8. The flexible laminated film of claim 1, wherein a difference between an edge of the flexible laminated film and a highest portion of the flexible laminated film is 5 mm or less.

9. The flexible laminated film of claim 1, wherein the flexible laminated film does not cause cracking upon bending for 240 hours with a bending radius of 2.5 mm.

10. The flexible laminated film of claim 1, wherein a Martens hardness of the hard coating layer is 350 N/mm² or more.

11. The flexible laminated film of claim 1, wherein the flexible laminated film is a cover window substrate for a flexible display device.

12. A display device comprising the flexible laminated film of claim 1.
